(19) United States
(12) Patent Application Publication
(10) Pub. No.: US 2009/0102887 A1
(43) Pub. Date: Apr. 23, 2009

(54) LIQUID EJECTION HEAD

(75) Inventors: Takeo Eguchi, Kanagawa (JP); Kazuyasu Takenaka, Tokyo (JP); Atsushi Nakamura, Kanagawa (JP); Iwao Ushinohama, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/066,353

(22) PCT Filed: Sep. 12, 2006
(86) PCT No.: PCT/JP2006/318070

§ 371 Date: Mar. 10, 2008

(30) Foreign Application Priority Data
Sep. 12, 2005 (JP) 2005-263174

(51) Int. Cl. B41J 2/14

(52) U.S. Cl. 347/47

(57) ABSTRACT

A line head that minimizes the influence of strain due to generation of thermal stress and minimizes the influence on printing results even when only the head chips are suddenly heated is provided. First strain-reducing portions 31 are formed in a nozzle plate by arranging at least one line of a plurality of holes in a direction perpendicular to an arrangement direction of nozzles 18 in regions near outer edges of end portions of head chips 11 in a longitudinal direction thereof. Second strain-reducing portions 32 are formed in the nozzle plate by arranging at least one line of a plurality of holes in the arrangement direction of the nozzles 18 from positions near the outer edges of the end portions of the head chips 11 in the longitudinal direction thereof toward central portions of the head chips 11 in the longitudinal direction thereof.

### TECHNICAL FIELD

The present invention relates to liquid ejection heads, and more particularly, to a technique for providing a nozzle plate having means for reducing strain due to thermal stress.

### BACKGROUND ART

In a conventional thermal-type liquid ejection head, heater elements are formed on a semiconductor substrate, a barrier layer is formed on the top surface thereof, and flow paths and liquid chambers for allowing a flow of liquid are formed. Then, lastly, a nozzle plate having many nozzles (holes) positioned in accordance with the arrangement of the heater elements is adhered together. The nozzle plate is generally made of metal or a polymeric film. In the former case, nickel electroforming, for example, is used. In the latter case, polyimide, for example, is used.

On the other hand, in a head chip that is integrated with the barrier layer, a surface on the side of the barrier layer is adhered to the nozzle plate, whereas the opposite surface thereof is fixed to a head support plate that is not directly in a fixed positional relationship with the nozzle plate to be precise. Accordingly, unless the head support plate and the nozzle plate are moved parallel to each other in the same direction, the head chip and the barrier layer disposed therebetween receive a shear stress.

In this case, the barrier layer that functions as an adhesive tends to receive a large influence because the barrier layer is softer than the head chip made of silicon and is more easily deformed.

Such strain hardly occurs in a monochrome serial head including a single head chip and a single nozzle plate. Even if the strain occurs, the problem is only between two components, and therefore the strain can be reduced by suitably selecting materials and/or changing the structure.

In comparison, in a line (long) head in which many nozzles are formed in a single (one) nozzle plate and a plurality of head chips are arranged in accordance with the position of each nozzle (refer to, for example, Japanese Unexamined Patent Application Publication No. 2003-170600), the following problems occur.

According to the above-mentioned Japanese Unexamined Patent Application Publication No. 2003-170600, that is, in the line head having a plurality of head chips arranged on a single nozzle plate, it is difficult to integrate a support member of the nozzle plate that defines a head surface with the structure for supporting the head chips that are adhered to the nozzle plate from the back. In such a case, there is a problem that the barrier layer, which is made of the softest material, finally receives a thermal stress which leads to deformation thereof.

FIG. 10 is a diagram illustrating manufacturing steps of a line head structure. The steps include:

(1) forming barrier layers on the surfaces of head chips 1 (back surfaces of the barrier layers are adhered to the head chips in this step);

(2) fixing a nozzle plate 2 to a head frame 3 by adhesion;

(3) adhering the surfaces of the barrier layers on the head chips 1 to the surface of the nozzle plate 2;

(4) fixing the back surfaces of the head chips 1 to a head-supporting member (flow-path plate) 4 with a flexible adhesive; and

(5) fixing the head-supporting member 4 to the head frame 3 by adhesion.

The steps are performed in the mentioned order.

In the line head assembled by the above-described method, the nozzle plate 2 is adhered to the head frame 3 in such a state that a tension is applied to the nozzle plate 2 in a normal temperature, and the back surface of the head chip 1 is adhered and fixed to the head-supporting member 4 with an adhesive.

In this structure, expansion and contraction of the entire body of the head due to thermal expansion are canceled by the stress applied by the head frame 3. Therefore, if each of the steps is adequately performed, there is almost no strain, or extremely small strain, in a stationary condition, that is, in a standby state.

However, also in the above-described structure, there is a possibility that local strain will occur. An example of such a case is sudden, continuous ejection started from a stationary state. Another example is concentration of ejecting operation at a particular head chip 1.

In the above-described cases, the head chip 1 itself is suddenly heated and expands, whereas the adjacent dummy chips D (described below) are not at all heated and therefore do not expand.

In addition, the thermal conductivity of the barrier layer is not so high because resin or rubber-based material is used. In contrast, the head chip (silicon) 1 that is heated is made of material with an extremely high conductivity. Therefore, if the head chip 1 is suddenly heated, only the head chip 1 expands.

FIG. 11 is a diagram showing a model in which the problem of thermal stress is simplified to one dimension.

FIG. 11 illustrates a sectional view of a structure around the contact area between the head chip 1 and the dummy chip D taken along a centerline of the head chip 1 along a nozzle line.

First, in the figure, (A) shows the state in which the temperature of the head is uniform over the entire body thereof (stationary or standby state). In this state, no problems occur because strain does not occur in the surface of the nozzle plate 2. In addition, also when the ambient temperature gradually changes, if the temperature is uniform over the entire body, no problems occur because the tension balance is maintained.

In comparison, referring to the figure, in an ejecting operation shown in (B), only the temperature of the head chip 1 adhered to the nozzle plate 2 becomes different from the temperature of other portions. Therefore, the tension balance is disrupted. Here, when the length of the head chip 1 in the longitudinal direction thereof is 16 mm, a temperature increase is 20° C., and a coefficient of linear expansion of the head chip (silicon) 1 is 2.6 ppm, the following amount of expansion occurs:

16×20×2.6=0.832 μm (Equation 1)

However, the above-described problem occurs in the state in which the heat of the head chip 1 is not yet transmitted to the head frame 3, or in the state in which there is a large temperature difference between the head chip 1 and the head frame 3. The above-described problem occurs when only the head chip 1 is expanded and when the expansion of such a level that occurs in the head chip 1 has not yet occurred in the head frame 3.

In addition, the dummy chip D is not heated or expanded. Therefore, in regions near the ends of the head chip 1 in the longitudinal direction thereof, strain in the surface of the nozzle plate 2 fixed to the expanded head chip 1 cannot be canceled, and there may be a case in which the deformation shown in FIG. 11(B) occurs.

The inventors of the present invention have found that two problems easily occur if the above-described strain occurs from the result of experiments. One of the problems is that adhesion between the head chip 1 and the nozzle plate 2 is easily lost. The other problem is that even when separation does not occur, ejection characteristics of the nozzles near the ends of the head chip 1 will be degraded or become unstable.

These two problems are both caused by the following basic reasons:

(1) Adhesion is more vulnerable to peel stress than to tensile stress.

It is said that a structure processed by adhesion is generally resistant to pulling but is vulnerable to compression and peeling (peeling: act of removing an adhered object by pulling the adhered object in a direction perpendicular to or nearly perpendicular to an adhesion surface, or removing adhered tape), although this depends on the characteristics and use of the adhesive. In the case of FIG. 11(B), when the nozzle plate 2 that is pushed by the compression stress but has no place to move is deformed, a portion near an end of the head chip 1 conceivably swells upward while being pushed toward the head chip 1. At this time, force that is applied at the boundary between the nozzle plate 2 and the barrier layer can be considered to have the same characteristics as peeling force.

(2) The barrier layer is easily deformed and adhesion stress is reduced under high temperatures.

When strain occurs between the head chips 1 and a force that causes deformation of the nozzle plate 2 is generated, a similar force should be generated at the dummy chip D in normal situations. However, heat is not generated at the side of the dummy chip D and the adhesion force is only slightly reduced because the barrier layer is not heated. Therefore, only the head chip 1, whose temperature is relatively high, is damaged.

Therefore, in a region around the barrier layer on the dummy chip D in which strong adhesion is provided and strength variation does not occur, history of strain remains on the nozzle plate 2. In other words, the adhesion force on the inner surface of the nozzle plate 2 is reduced, which causes progressive peeling, and the barrier layer is weakened due to repeated use thereof. Finally, adhesion failure may occur and the characteristics of the liquid chambers may be influenced.

In the above, problems caused by the head chips 1 arranged along a single line have been discussed. However, in the structure of a line head, the head chips 1 are two-dimensionally arranged (staggered arrangement) to ensure the continuity of nozzle lines. Therefore, problems other than those of one dimension also occur.

FIG. 12 is a diagram illustrating the arrangement of the head chips 1 and the dummy chips D in a line head. Here, the “dummy chip D” refers to a head that has the same shape as the head chips 1 but provides no ejecting function, or a head similar to the head chips 1 without heater elements or liquid chambers (head in which only the barrier layer is formed). The dummy chips D form a common flow path together with the head chips 1.

As shown in FIG. 12, in a single line head having the structure in which the head chips 1 are arranged in a staggered pattern, there are at least two lines of the head chips 1.

Thus, in the line head, the dummy chips D and the head chips 1 are alternately arranged. Therefore, between lines of the head chips 1 arranged adjacent to each other, the head chips 1 being heated are positioned in a staggered pattern (checkered pattern). Therefore, problems of the strain occurs in two dimension as a whole.

In addition, in FIG. 12, the head chip 1 at the upper left and the head chip 1 at the lower right are arranged such that the nozzle lines thereof are continuously arranged at an accurately constant pitch. In the staggered arrangement, a region near a connecting portion between the head chips 1 is the region where large strain occurs due to heat generated by the head chips 1. Therefore, strain caused by clockwise force in FIG. 12 occurs around the center point of the connecting portion between the head chips 1, that is, the center of the common flow path in the nozzle plate 2. Thus, there is a problem that when a particular head chip 1 is suddenly heated, complicated strain occurs at the ends of the head chip 1 in a region surrounding the head chip 1, and accordingly the liquid chambers are slightly deformed.

Therefore, an object of the present invention is to provide a line head that minimizes the influence of strain due to generation of thermal stress and minimizes the influence on printing results even when only the head chips are suddenly heated.

### DISCLOSURE OF INVENTION

The present invention solves the above-described problems by the following solving means.

According to the invention of claim 1, which is one of the present invention, a liquid ejection head comprises a nozzle plate having nozzles formed therein; and head chips in which heater elements are arranged in one direction. The plurality of head chips are arranged on the nozzle plate in series in a line pattern such that each of the heater elements on the head chips is disposed at a position corresponding to each of the nozzles in the nozzle plate. The liquid ejection head is characterized by comprising strain-reducing portions formed in the nozzle plate by arranging at least one line of a plurality of holes in a direction perpendicular to an arrangement direction of the nozzles in regions near outer edges of end portions of the head chips in a longitudinal direction thereof.

According to the invention of claim 5, which is another one of the present invention, a liquid ejection head, comprises a nozzle plate having nozzles formed therein; and head chips in which heater elements are arranged in one direction. The plurality of head chips are arranged on the nozzle plate in series in a line pattern such that each of the heater elements on the head chips is disposed at a position corresponding to each of the nozzles in the nozzle plate. The liquid ejection head is characterized by comprising strain-reducing portions formed in the nozzle plate by arranging at least one line of a plurality of holes in an arrangement direction of the nozzles from positions near outer edges of end portions of the head chips in a longitudinal direction thereof toward central portions of the head chips in the longitudinal direction thereof.

When only the head chips are suddenly heated and the head chips receive thermal stress in a direction in which the head chips are elongated, strain occurs in the nozzle plate in regions between the head chips. However, according to the above-described invention, the strain-reducing portion is deformed to make the influence, such as deformation of nozzles themselves, on other components as small as possible.

In addition, the liquid ejection heads according to the present invention correspond to an (inkjet) head 10 of an inkjet printer according to an embodiment described below. In the embodiment, sixteen head chips are linearly arranged on a single nozzle plate 17, and lines of head chips are provided in pairs to obtain a line head (length corresponding to A4 size). The four pairs of the lines are provided for each of four colors, which are Y (yellow), M (magenta), C (cyan), and K (black), to obtain a liquid ejection head that functions as a four-color line head.

According to the liquid ejection heads of the present invention, the influence of strain due to generation of thermal stress is minimized, and the influence on printing results is minimized even when only the head chips are suddenly heated.

### BRIEF DESCRIPTION OF DRAWINGS

FIG. 1 is a perspective view illustrating the structure of a head according to the present embodiment.

FIG. 2 is a plan view illustrating a line head according to present embodiment.

FIG. 3 is a plan view illustrating the basic concept of the present embodiment.

FIG. 4 is a diagram illustrating the shape according to Example 1.

FIG. 5 is a diagram illustrating the shape according to Example 2.

FIG. 6 is a diagram schematically illustrating processing steps for leaving a resist layer on an electroform master, which can be referred to as a front-end process performed before electroforming.

FIG. 7 is a diagram illustrating two kinds of electroforming steps.

FIG. 8 shows a table of specifications of holes according to Example 1 to Example 4.

FIG. 9 is a diagram illustrating the structure of Example 4.

FIG. 10 is a diagram illustrating manufacturing steps of a line head structure (known example).

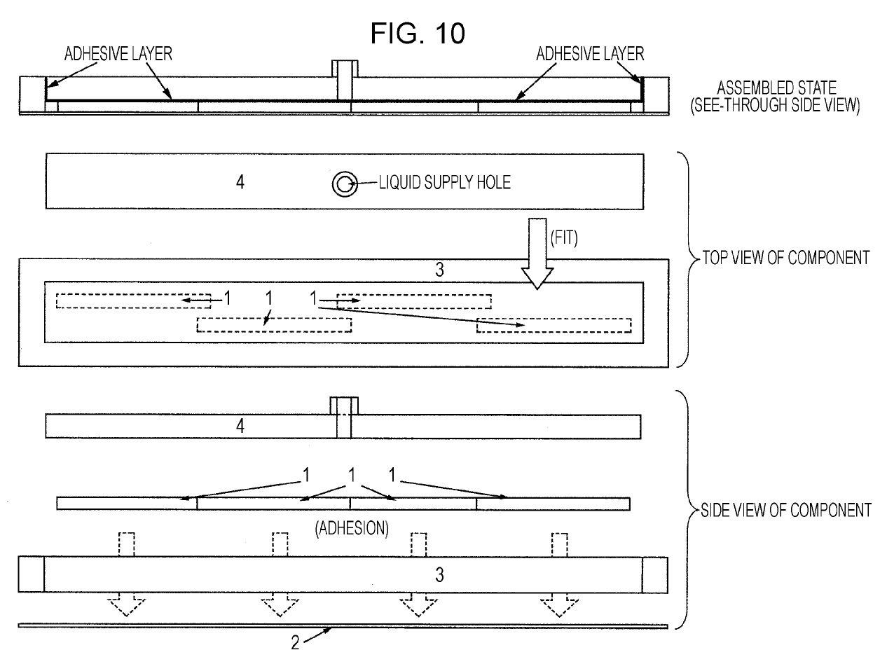

FIG. 11 is a diagram illustrating a model in which the problem of thermal stress is simplified to one dimension (known example).

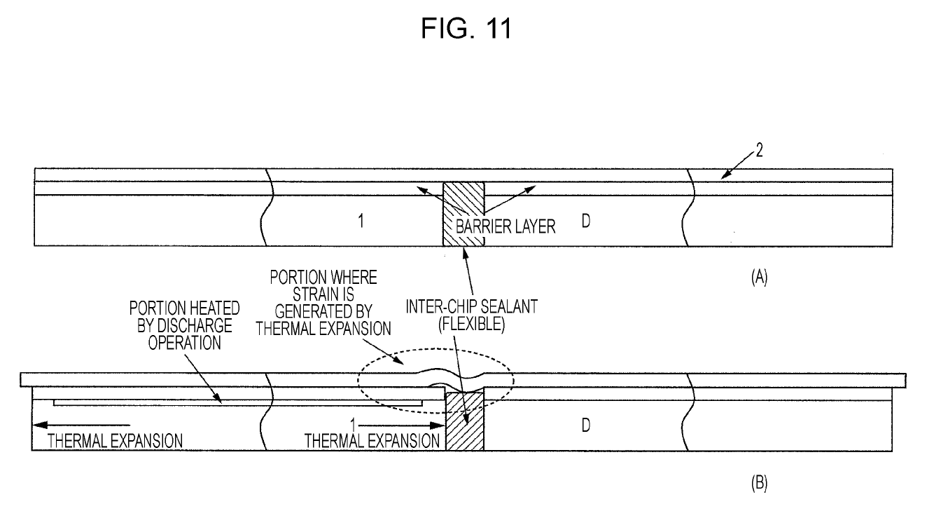

FIG. 12 is a diagram illustrating an arrangement of head chips and dummy chips in a line head (known example).

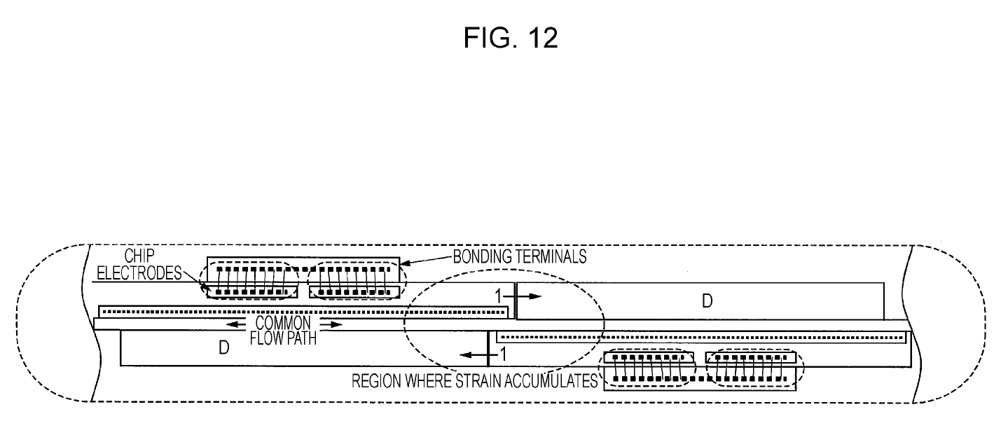

### BEST MODE FOR CARRYING OUT THE INVENTION

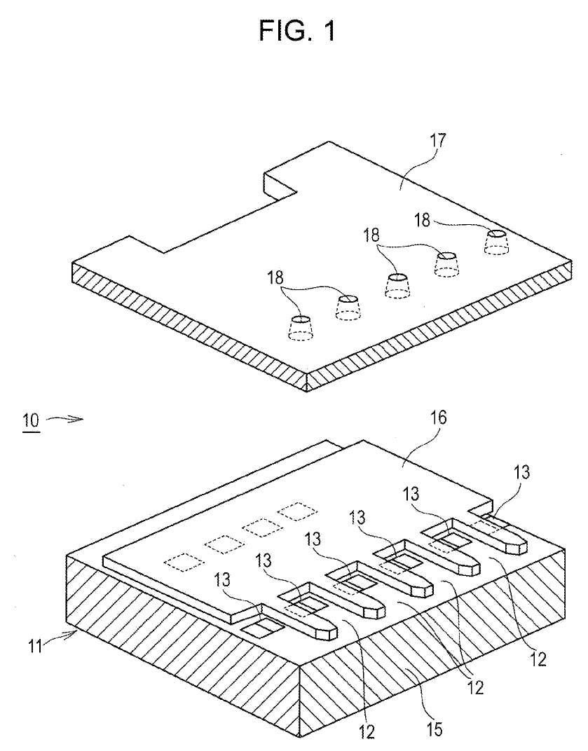

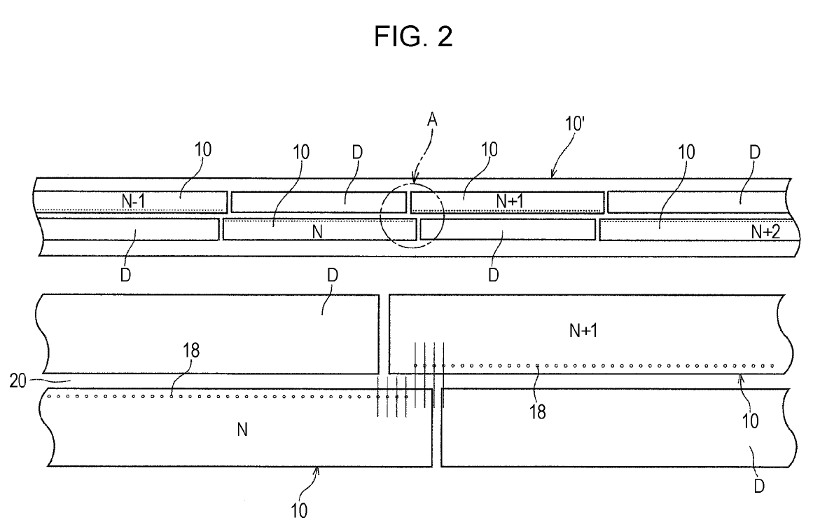

An embodiment of the present invention will be described below with reference to the drawings, etc. FIG. 1 is a perspective view illustrating the structure of a head 10 according to the present embodiment. In addition, FIG. 2 is a plan view illustrating a line head 10′ of present embodiment. Here, in FIGS. 1 and 2, strain-reducing portions, which are characteristic parts of the present embodiment, are not shown.

In FIG. 1, the (single) head 10 includes a head chip 11 and a nozzle plate 17. In other words, a component obtained by removing the nozzle plate 17 from the head 10 is called the head chip 11.

In FIG. 1, a semiconductor substrate 15 is made of silicon, glass, ceramic, etc. In addition, heater elements 13 are deposited on a surface (top surface) of the semiconductor substrate 15 using a fine processing technology, such as technology for manufacturing semiconductor or electronic devices (for example, films of material of the heater elements 13 are formed by a plasma sputtering method). The heater elements 13 are electrically connected to an external circuit via a conductor portion (not shown) that is formed on the semiconductor substrate 15 in a similar manner, and through a drive circuit, a control logic circuit, etc., which are similarly disposed inside.

In addition, the barrier layer 16 is formed on the semiconductor substrate 15 at the side of the heater elements 13, and is obtained by forming a pattern of photosensitive resin in a region excluding the regions surrounding the heater elements 13.

More specifically, the barrier layer 16 is formed of, for example, photosensitive cyclized rubber resist or exposure-curable dry film resist, and is formed by applying the resist over the entire surface of the semiconductor substrate 15 on which the heater elements 13 are formed and removing unnecessary portions by photolithography processes.

In addition, the nozzle plate 17 is formed by, for example, an electroforming technique using nickel (Ni) such that a plurality of nozzles 18 are arranged. Then, positioning is performed such that the position of each nozzle 18 in the nozzle plate 17 corresponds to the position of each respective heater element 13 on the semiconductor substrate 15, and the nozzle plate 17 is adhered to the barrier layer 16.

Each of ink chambers 12 is formed by the semiconductor substrate 15, the barrier layer 16, and the nozzle plate 17 so as to surround the heater element 13. In other words, the semiconductor substrate 15 and the heater elements 13 form bottom walls of the ink chambers 12, and the barrier layer 16 forms three side walls of the ink chambers 12. The nozzle plate 17 forms top walls of the ink chambers 12.

In addition, each ink chamber 12 has an opening area at a lower right region thereof in FIG. 1, and this opening area communicates with a common flow path 20 (see FIG. 2). Therefore, ink in the ink tank (not shown) passes through a common ink flow path, and is supplied to each of the ink chambers 12 through the opening area thereof.

In addition, FIG. 2, which illustrates a line head 10′, shows four heads 10 (“N−1”, “N”, “N+1”, and “N+2”) and dummy chips D. Thus, the heads 10 are arranged in parallel. Here, the line head 10′ is obtained by adhering a plurality of head chips 11 in series on a single nozzle plate 17 having a plurality of nozzles 18 formed therein.

In addition, in the nozzle plate 17, each of the nozzles 18 including the nozzle 18 at each end of the adjacent heads 10 is arranged at a constant pitch P. More specifically, as shown in a detailed portion A, the pitch between the nozzle 18 at the right end of the N^{th} head 10 and the nozzle 18 at the left end of the N+1^{th} head 10 is set to be equal to the pitch P of each nozzle 18 in each head 10.

In addition, as shown in FIG. 2, dummy chips D are disposed at both ends of each head 10 in the longitudinal direction. More specifically, in a single line, a head 10, a dummy chip D, a head 10, a dummy chip D, . . . , are arranged in that order. Thus, the heads 10 and the dummy chips D are alternately arranged.

In addition, the common flow path 20 of the line head 10′ is formed in a region surrounded by the heads 10 and the dummy chips D.

In addition, a required number of the above-described line heads 10′ may be arranged in a direction perpendicular to the arrangement direction of the nozzles 18 to form line-head lines. Color printing can be performed by supplying inks of different colors to the respective line-head lines. For example, when four line-head lines are provided for Y (yellow), M (magenta), C (cyan), and K (black), a color inkjet printer can be obtained.

In addition, ink of each color is supplied from ink tanks (not shown) for four colors that are connected to the respective line heads 10′, so that ink is contained in the ink chambers 12 shown in FIG. 1. Then, when a pulse current is applied to the heater elements 13 on the basis of print data for a short time (for example, 1 to 3 μsec), those heater elements 13 are suddenly heated and bubbles can be generated in portions of ink that are in contact with the heater elements 13 by film boiling. The bubbles expand to push away a certain volume of ink, and ink with the same volume as the ink pushed away is ejected from the nozzles 18 as ink droplets. The ink droplets land on a recording medium to form a line of dots. Thus, a plurality of lines of does are formed so as to form an image.

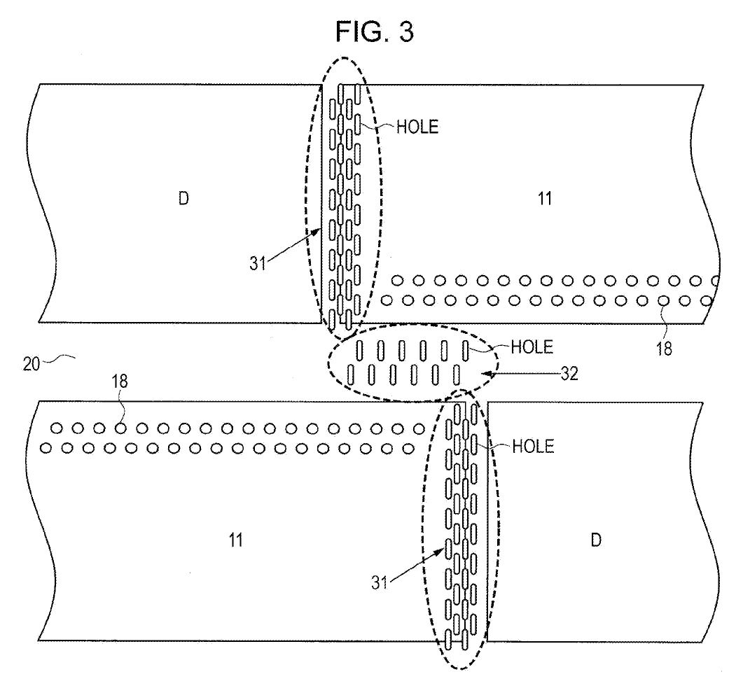

FIG. 3 is a plan view illustrating the basic concept of the present embodiment. Here, in the case of FIG. 3, only the nozzle plate 17 should be seen in practice. However, the head chips 11 and the dummy chips D are also shown in the figure to for convenience of explanation.

As described above, the head chips 11 are alternately arranged in a staggered pattern, and the head chips 11 and the dummy chips D are disposed adjacent to each other.

Here, in the present embodiment, four hole lines are formed between the head chips 11 and the dummy chips D, and these groups of hole lines serve as first strain-reducing portions 31 according to the present embodiment.

In particular, in FIG. 3, the hole lines of the first strain-reducing portions 31 extend over the entire length of the short sides of the head chips 11. This is because the strain absorbing effect is considered to be further increased when the length of the first strain-reducing portions 31 is longer then the length of the short sides of the head chips 11. In addition, it is because the holes of the first strain-reducing portions 31 are exposed to liquid in a region between the opposing head chips 11 because they come into contact with the liquid in the common flow path 20, and a caution different from that required in the case in which the liquid is sealed while remaining only between the dummy chips D is necessary.

In addition, each of the holes of the first strain-reducing portions 31 has an ellipsoidal or oval shape, and is elongated in a direction perpendicular to the arrangement direction of the nozzles 18. The first strain-reducing portions 31 reduce stress by deforming the holes. Therefore, the holes have an elongated shape so that hey can be easily deformed in response to stress applied in the arrangement direction of the nozzles 18.

In addition, sealant is provided under the first strain-reducing portions 31 (on the bottom surface of the nozzle plate 17) to prevent the liquid from entering. However, even if there is a possibility of entrance of the liquid, the hole diameter may be set sufficiently small (for example, the minor-axis dimension may be equal to or smaller than that of the nozzles 18) or the thickness may be set to be adequately small (for example, equal to or less than ½ of the thickness of the nozzle plate 17).

In addition, the numbers of columns and rows of the holes are not particularly limited as long as the effect of reducing the strain to such a level that the adhesion between the nozzle plate 17 and the head chip 11 is prevented from being degraded and the shape of the ink chambers 12 is prevented from being changed can be obtained.

In addition, as shown in FIG. 3, second strain-reducing portions 32 include two lines of holes and are formed along the sides of the head chips 11 facing the common flow path 20. In addition, with regard to the positions, the second strain-reducing portions 32 are formed from positions near the ends of the head chips 11 in the longitudinal direction thereof toward central portions of the head chips 11. More specifically, the holes are arranged in a direction of the common flow path 20 (direction perpendicular to the arrangement direction of the holes of the first strain-reducing portions 31, or the arrangement direction of the nozzles 18).

The second strain-reducing portions 32 are provided to reduce the influence of strain that occurs at positions near the ends of the head chips 11 in regions between the opposing head chips 11. The first strain-reducing portions 31 and the second strain-reducing portions 32 have different structures because the amount and characteristics of the strain differ between the regions corresponding thereto. In the first strain-reducing portions 31, the main cause of the strain is compressive stress. In comparison, in the second strain-reducing portions 32, the main cause of the strain is considered to be a shear stress in a plan view.

Therefore, the first strain-reducing portions 31 and the second strain-reducing portions 32 are deformed in different manners. This is because the amount of strain per unit length differs between them, the influence differs between the compressive strain and the shear strain, and the thickness of the nozzle plate 17 is 12 to 13 μm, which is small.

For example, since an average distance between the head chips 11 and the dummy chips D is about 100 μm, it corresponds to one-half (with regard to the overall extension of each head chip 11, if the center of the head chip 11 is fixed, the extension at each end is ½ of that of the entire body) of 0.832 μm, which is an amount of extension caused in response to a change of 20°. Accordingly, the amount of extension is slightly larger than 0.4 μm (extension of 0.4%).

In comparison, in the case of shearing, since the distance between the opposing head chips 11 is set to about 250 μm, if the opposing head chips 11 are moved in the opposite directions by 0.4 μm each with the above distance therebetween, it can be calculated as 0.83/250=0.33%. Therefore, quantitatively, it can be reduced about 80%.

In addition, the thermal stress causes large strain in an area between the ends of the head chips 11. Therefore, if it is only necessary to reduce the influence of the strain, the length of the second strain-reducing portions 32 is sufficient if the second strain-reducing portions 32 extend from the corners of the head chips 11 on the sides where the heater elements 13 are arranged by a distance long enough to eliminate the problem caused by the strain.

Furthermore, if the nozzle plate 17 is formed by nickel electroforming as in the present embodiment, there may be a case in which a particular caution is required.

More specifically, in a nickel electroforming process, there is a fact that the accuracy in the hole-forming step (hole diameter accuracy) is influenced by the size of the surrounding holes and the distance from the target hole to the surrounding holes. In the case in which the hole-diameter accuracy is required to be as high as possible as in the case of forming the nozzles 18, it is important that the ambient condition be such that all of the holes are as geometrically similar to each other as possible. In particular, if it is necessary to form holes other than the nozzles 18 near the nozzles 18 for some reason, it is preferable that all of the holes are identical to each other or as similar to each other as possible, so that similar influences are received even if the influences are unavoidable.

With regard to the holes of the second strain-reducing portions 32, although the size of each hole is not particularly large, the total area is somewhat large because the holes are elongated and the number of holes is large. Therefore, there is a possibility that the accuracy of the nozzles 18 will be influenced. In other words, even when the nozzles 18 have the same diameter according to the design of resist (photomechanical mask for processing the nozzles 18), there is a possibility that the nozzles 18 near an area where the second strain-reducing portions 32 are provided and the nozzles 18 near an area free from the second strain-reducing portions 32 have slightly different hole diameters. This leads to nonuniform density in the case of a printer or the like.

To make such a possibility as small as possible, the second strain-reducing portions 32 preferably extend over a region faced by the heater elements 13 instead of only at the corners of the head chip 11. In other words, the second strain-reducing portions 32 preferably extend over the entire length of the head chip 11 in the longitudinal direction thereof along the arrangement of the nozzles 18.

Therefore, if the first strain-reducing portions 31 and the second strain-reducing portions 32 are formed in a preferred manner, an angular-U-shaped hole group is formed so as to extend along three sides of the head chips 11 (side facing the heater elements 13 and sides at both ends in the longitudinal direction). Such formation of the holes may raise a doubt about the supporting strength of the head chips 11. However, from the viewpoint of preventing unnecessary deformation of the ink chambers 12, no particular problems occur because the nozzle plate 17 and the head chips 11 are originally required to move together and the head chips 11 themselves are supported by a supporting plate (flow-path plate) at the back.

In addition, the shape of the holes of the first strain-reducing portions 31 and the second strain-reducing portions 32 may be any of circular, elliptical, oval, rectangular, hexagonal, etc. However, to efficiently absorb strain with a small number or holes, the holes are preferably elongated in a direction perpendicular to the direction in which the stress is applied when the strain occurs, so that deformation can be facilitated. If such a structure is used, strain can be sufficiently absorbed with holes having a small width. The elongated holes are expected to show favorable characteristics for strain of displacement near the second strain-reducing portions 32. However, a larger effect can be obtained in areas between the head chips 11 and the dummy chips D which are preferably small.

In addition, if it is only necessary to absorb strain, the first strain-reducing portions 31 and the second strain-reducing portions 32 may be formed at a suitable interval. However, the second strain-reducing portions 32, in particular, preferably has a certain positional relationship with the nozzles 18. Furthermore, a filter for dirt and dust is normally provided at an area near the nozzles 18 of the head chip 11 where the liquid is received. Therefore, preferably, there is also a certain relationship with this filter because the influence of shock waves generated in the flow path during ejection (interference between the ejection nozzles 18) and the like can be reduced to within a constant, limited range.

For the above-described reasons, it is considered to be preferable to set the pitch of the holes of the second strain-reducing portions 32 equal to the pitch of the heater elements 13 (nozzles 18).

In addition, with regard to the positions of the first strain-reducing portions 31 and the second strain-reducing portions 32, the distances to the head chips 11 are set as described below.

Originally, the source of generation of the strain is the head chips 11 that are heated. Therefore, it can be considered that the first strain-reducing portions 31 and the second strain-reducing portions 32 provided for reducing the strain are preferably positioned as close to the head chips 11 as possible. Therefore, the effects can be maximized when they are formed so as to overlap the head chips 11 without sacrificing the barrier layer 16 (for example, without changing the original shape of the barrier layer 16 or reducing the adhesion strength to form the holes).

In particular, in the present embodiment, the barrier layer 16 is designed to be positioned to be slightly smaller compared to the surface of the head chip 11 (by about 50 to 100 μm at both ends of the head chip 11 and about 20 to 30 μm in an area outside a pole of the filter in a region where the heater elements 13 are provided) to prevent peeling during dicing (step of separating the head chips 11 by cutting the wafer) and the influence of burr. In this case, the strain can be effectively reduced by arranging the holes near the head chips 11 without overlapping the barrier layer 16.

The above-described embodiment provides the following effects:

(1) The heads 10 can be protected.

Even if the ejecting operation is started immediately after turning on the electricity while the device temperature is low, the risk of damaging the head 10 is reduced.

(2) The problem of peeling of the nozzle plate 17 can be reduced.

Without the application of the present embodiment, partial peeling of the nozzle plate 17 easily occurred due to strain caused by thermal stress at, in particular, the ends of the head chips 11 in the longitudinal direction thereof. However, the problem has been greatly reduced after the application of the present embodiment.

(3) The amount of deformation of the ink chambers 12 due to thermal strain can be reduced.

If the ink chambers 12 are even slightly deformed, the ejection characteristics will change. In the case in which there is a large distance between the recording medium and the nozzles 18 as in an inkjet printer or the like, the influence is increased due to the distance. Therefore, if the angle of ejection from the nozzles 18 is even slightly changed, when the ink droplets land on the recording medium, unignorable displacements will be observed (as striped pattern).

(4) The ejection characteristics of the head 10 can be made uniform.

Since the deformation of the nozzles 18, the ink chambers 12, etc., can be reduced, the overall uniformity can be increased. In addition, when the uniformity is increased, the image quality can be improved in inkjet printers and the like.

(5) The resistance of the heads 10 can be improved.

Since the repeated stress is small at the ends of the head chips 11, the number of times printing can be performed with the same quality can be increased.

(6) The life of the heads 10 can be increased.

Since the period in which the quality can be maintained at a high level is increased, the running cost can be relatively reduced as a result.

### EXAMPLE 1

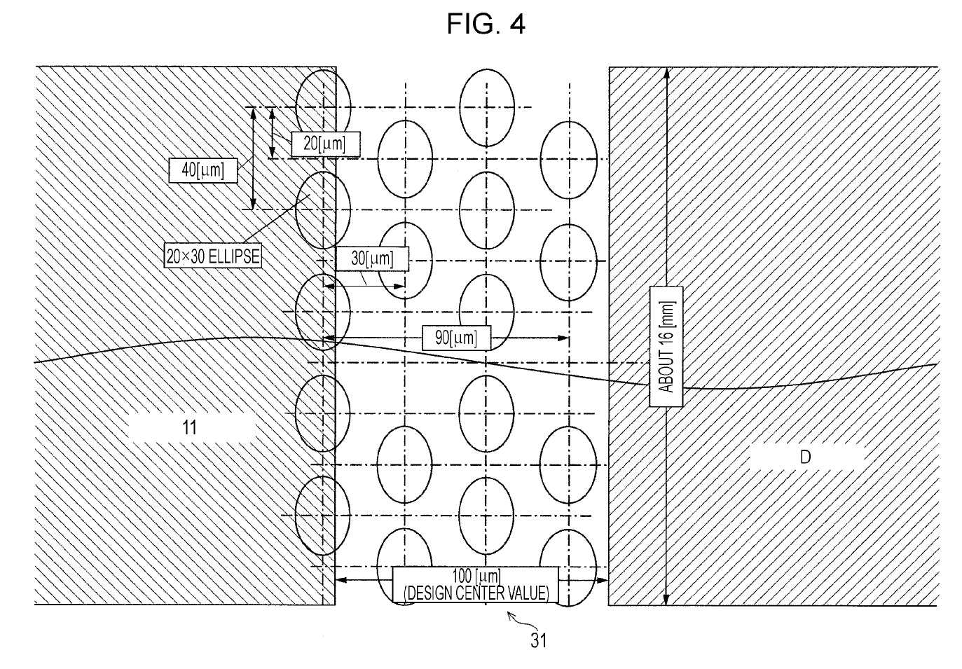

FIG. 4 illustrates the shape according to Example 1. In FIG. 4, dimensions for forming the resist for the first strain-reducing portion 31 according to Example 1 are shown.

An experiment was performed by applying the present embodiment to an inkjet printer. As a result, in samples obtained by applying the present embodiment, the time period until nonuniform density that is probably due to degradation was observed was improved by about one digit compared to samples obtained without applying the present embodiment. More specifically, in the experiment, a photographic image with a print ratio of about 20% was printed on A4 size sheets and was observed. When the line head 10′ to which the present embodiment was not applied was used, nonuniform density and striped pattern were observed after printing on 200 to 300 sheets. In comparison, when the line head 10′ having the first strain-reducing portions 31 was used, almost no change was observed even after printing on 2,500 sheets.

### EXAMPLE 2

### Example 3

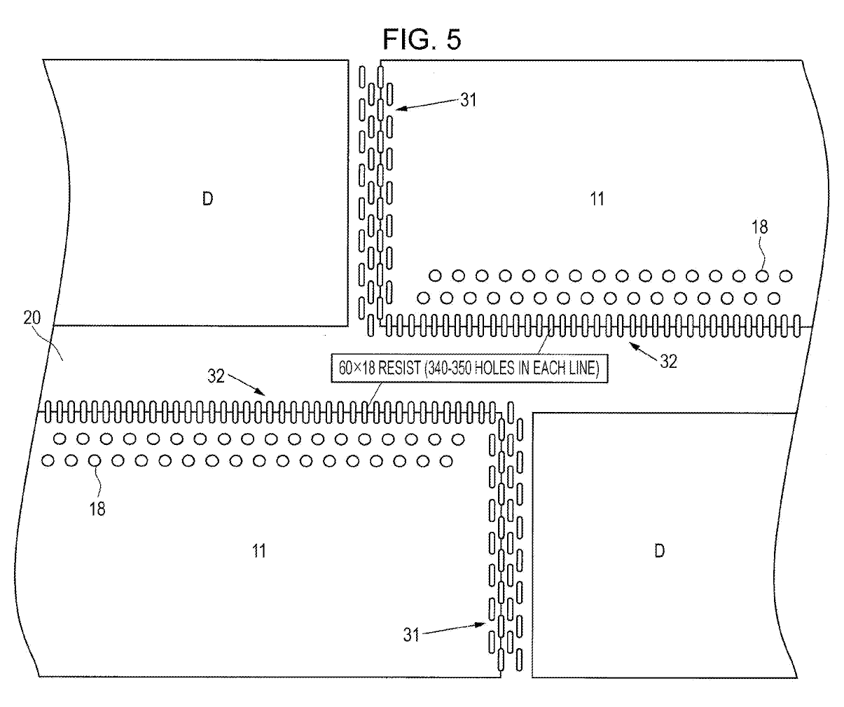

In Example 2 and Example 3, both the first strain-reducing portions 31 and the second strain-reducing portions 32 were provided. Here, the shape of Example 2 is similar to that shown in FIG. 3, and the shape of Example 3 is shown in FIG. 5.

When the second strain-reducing portions 32 were provided in addition to the first strain-reducing portions 31 as described above, the resistance was apparently improved. More specifically, it was confirmed that quality equal to or higher than that obtained after printing on 2,500 sheets according to Example 1 was obtained even after printing on 10,000 sheets.

Next, a side effect of the second strain-reducing portions 32 will be described.

In Example 2 and Example 3, it was confirmed that the resistance can be greatly improved compared to Example 1 by providing the second strain-reducing portions 32. However, it was also discovered that there is a new side effect caused by providing the second strain-reducing portions 32.

Here, the “side effect” is a problem that the liquid leaks out to the surface of the nozzles 18 when the opening area of the holes is increased to some level or more because the second strain-reducing portions 32 are positioned in the common flow path 20.

However, the inner pressure of the common flow path 20 is set to be lower than the atmospheric presser at least in a standby state, and therefore the liquid does not continuously leak out during a normal ejecting operation. The problem is that when the surface of the nozzles 18 is wiped by a roller, a wiper, or the like in a cleaning process, the surface pressure may be locally reduced. Alternatively, if the surface of the cleaner that is pushed into the holes comes into contact the liquid, the liquid is attracted to the cleaner due to the capillary effect. Accordingly, the liquid is sucked out.

In other words, the structure appears as if the number of nozzles, which are openings for the liquid, is increased, and the liquid is unnecessarily consumed in the cleaning process. To eliminate this problem, the opening area of the holes of the second strain-reducing portions 32 can be simply reduced. An electroforming process used to minimize the leakage of the liquid and to deal with the strain caused by heat will now be described.

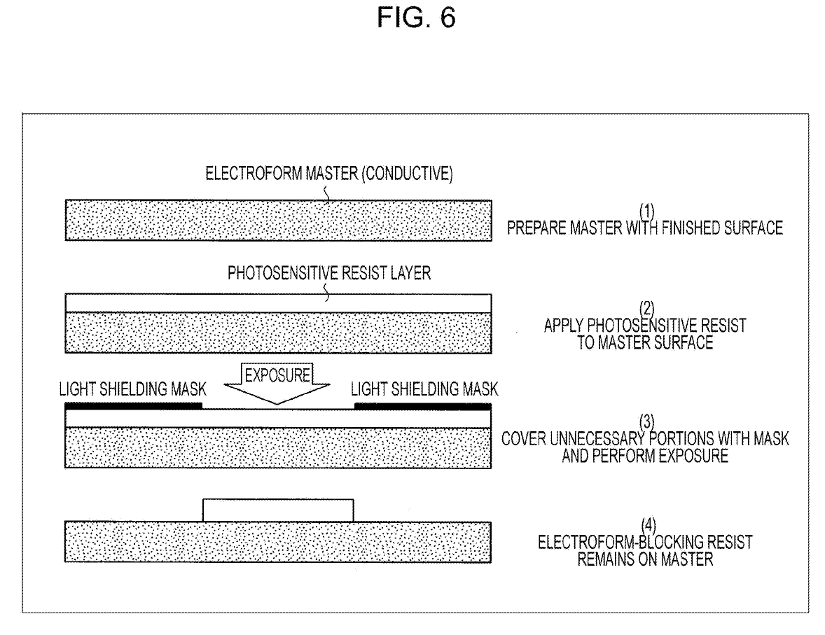

FIG. 6 is a diagram schematically illustrating processing steps for leaving a resist layer on an electroform master, which can be referred to as a front-end process performed before electroforming. The principle of electroforming is opposite to that of an electrolysis process. Metal ions dissolved in electrolyte are deposited on a surface of a master. The deposition occurs in an area where electrical conductivity is provided on the surface of the master, and no deposition occurs in an area where the surface of the master is covered with a non-conductive member (resist layer in FIG. 6) since current does not flow via the liquid.

Referring FIG. 6, a mask is designed in advance such that the resist remains in an area where metal (nickel in this example) is not to be deposited as a result of the electroforming process. The resist material that was actually used was so-called “negative resist” which remains only in an area where light is irradiated and which is dissolved by an agent in other areas after the exposure.

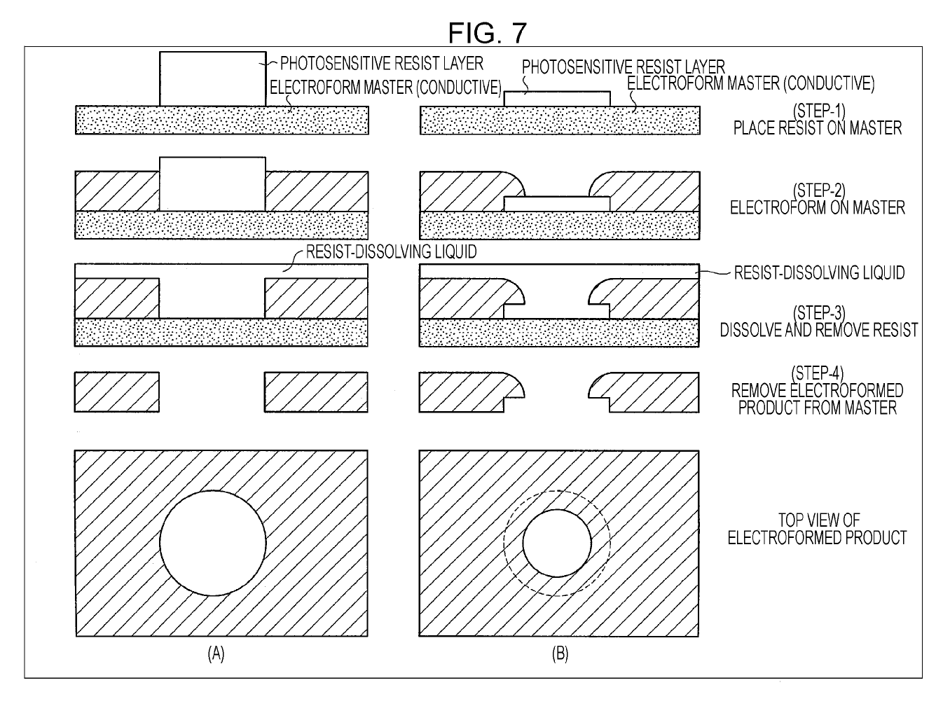

The master having the resist layer disposed thereon is then subjected to an electroforming step. As shown in FIG. 7, one of two alternatives is selected in accordance with the relationship between the resist thickness and the electroforming thickness.

(1) The Case Shown in FIG. 7(A) in which the Resist Thickness is Larger than the Electroforming the Thickness.

The metal is not at all deposited on the surface in an area where the resist is provided. Therefore, the boundaries between the resist and the electroformed product extend along the side walls of the resist. With the negative resist, the walls are normally substantially perpendicular to the master. In other words, the holes left in the surface after the electroforming process using this method have the exact area corresponding to the shape (circular, oval, elliptical, square, etc.) that is simply defined by the resist with respect to the surface of the nozzles 18, and inner walls of the holes are perpendicular to the surface.

The thus-completed nickel electroformed sheet has an extremely small thickness of 12 to 13 [μm] in practice, and is difficult to handle. Therefore, the sheet is handled as a product while the sheet is still tightly adhered to the master, and the master is removed after the surface is adhered to the ceramic head frame by heating it to a high temperature.

(2) The Case Shown in FIG. 7(B) in which the Resist Thickness is Smaller than the Electroforming the Thickness.

In this case, similar to the case of (A), the electroformed layer grows along the side walls of the resist until the electroforming thickness reaches the resist layer thickness. When the thickness of the electroformed layer exceeds the thickness of the resist, the electroformed product grows not only in the vertical direction in the figure (upward on the page) but also in a horizontal direction. The electroformed product grows at a substantially constant speed if the ion density distribution and the electric potential distribution are constant therein. Therefore, in a cross section perpendicular to the surface of the nozzles 18, the electroformed product grows in the shape of a sector having a vertex at the top of the resist.

After the above-described processes, when (step-2) is finished, a “hood” having a smoothly curved surface is formed so as to cover the top surface of the resist, as shown in the figure. In this example, the basic figure formed by the resist is circle. Therefore, as is clear from the top view, the hood is shaped such that a hollow space is provided at the inside. According to this method, basically, the thickness of the resist can be reduced without limits. Therefore, if the thickness of the resist can be accurately reduced, the electroforming process can be performed while leaving almost no recess corresponding to the resist in the surface. In such a case, the structure formed by the resist has a smooth quarter-circle shape at the edge thereof if the electric potential distribution and the average density distribution of the ions are constant.

If the resist for electroforming is formed so as to have two different heights, holes having the shape of FIG. 7(A) and holes having the shape of FIG. 7(B) can be formed at the same time. However, generally, the resist layer is single-layered and it is necessary to select one of the shapes depending on the purpose. The actually formed nozzles 18 had the structure shown in FIG. 7(B) with the top side in the figure positioned at the inner side of the nozzle plate. Also in the case of forming the first strain-reducing portions 31 or the second strain-reducing portions 32, there is no choice but to set the thickness of the resist smaller than the electroforming thickness, as shown in FIG. 7(B). Therefore, the outer size of the hole shape explained above and shown in the figures are the values of the shape of the resist, and are not the values of the openings formed as a result.

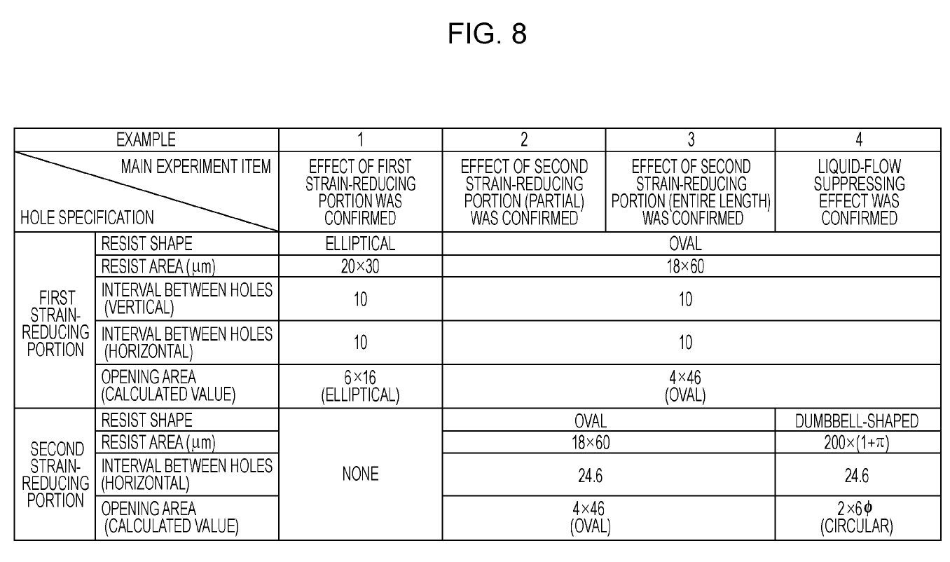

As can be understood from FIG. 7(B), the size of the holes is determined only after three values are determined: (1) the size of projection area of the resist on the master surface; (2) the thickness of the resist, and (3) the overall thickness of the electroformed layer. The projection area has already been described above. In the examples, the center value of resist thickness was 5 [μm] and that of the overall electroforming thickness was 13 [μm]. FIG. 8 shows a table of specifications of holes according to Examples 1 to 3 and Example 4, which will be described below.

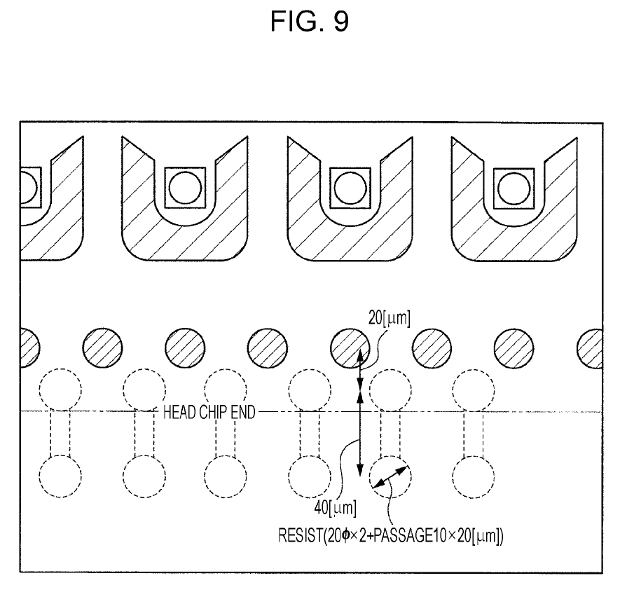

As described above, with the shape of the holes of the second strain-reducing portions 32 of Example 3, the area of openings of the holes are too large to be ignored, and there was a side effect that the liquid leaks out. Therefore, the structure of Example 4 shown in FIG. 9 was created as a structure that sufficiently satisfies the requirements regarding the strain and prevents the liquid from leaking out.

In this structure, the holes have an elongated shape in which only the circular portions at the ends are actually formed as openings and portions disposed between the circular portions are not formed as openings but as portions with small nozzle thickness by reducing the width of the resist. Instead of reducing the width over the entire length, the circular portions are purposely provided at the ends as openings. This is because of the following reasons:

1) If the area of the resist is reduced to a certain area or less, the adhesion force between the resist and the master is reduced and the possibility that the resist will be peeled off in a washing step and defects will occur will be increased. To maintain the adhesion force, it is effective to increase the adhesion force at the periphery, in particular, at the longitudinal ends, of the adhered object (remaining resist pattern). Therefore, it is effective to make the area the ends larger than the area at the central portion and form the resist in a dumbbell shape.

2) After the electroforming process, it is necessary to remove the unnecessary resist. Normally, the resist is dissolved with an agent (potassium hydroxide in this example). In the dissolving step, it is necessary to provide openings and immerse the electroformed surface in the agent. In this step, if there is a portion where the resist is arranged but no opening is provided, the resist remains on the master. The resist itself is made of a kind of non-conductive plastic, and causes no electrical damage even if it remains. However, in the case in which the liquid flows along the surface of the nozzle plate or in an assembly step in which dust and dirt cause severe problems, the resist that has been peeled off may case adverse effects as dust. Accordingly, if there are openings at least at the ends as in the holes formed in Example 4, the agent can flow though the openings to dissolve the resist directly below. Thus, the possibility that the resist will remain on the master can be effectively reduced (in comparison, if there is no openings, 100% of the resist remains on the master, and the problem of dust occurs after the removal of the master).

1. A liquid ejection head, comprising:
a nozzle plate having nozzles formed therein; and
head chips in which heater elements are arranged in one direction,
wherein the plurality of head chips are arranged on the nozzle plate in series in a line pattern such that each of the heater elements on the head chips is disposed at a position corresponding to each of the nozzles in the nozzle plate, and
wherein the liquid ejection head is characterized by comprising
strain-reducing portions formed in the nozzle plate by arranging at least one line of a plurality of holes in a direction perpendicular to an arrangement direction of the nozzles in regions near outer edges of end portions of the head chips in a longitudinal direction thereof.

2. The liquid ejection head according to claim 1, characterized in that the strain-reducing portions extend over the entire length of the head chips in a lateral direction thereof.

3. The liquid ejection head according to claim 1, characterized in that the holes have an elongated shape extending in the direction perpendicular to the arrangement direction of the nozzles.

4. The liquid ejection head according to claim 1, characterized in that at least some of the holes are formed so as to be positioned in areas of the head chips when the holes are projected onto the head chips.

5. A liquid ejection head, comprising:
a nozzle plate having nozzles formed therein; and
head chips in which heater elements are arranged in one direction,
wherein the plurality of head chips are arranged on the nozzle plate in series in a line pattern such that each of the heater elements on the head chips is disposed at a position corresponding to each of the nozzles in the nozzle plate, and
wherein the liquid ejection head is characterized by comprising
strain-reducing portions formed in the nozzle plate by arranging at least one line of a plurality of holes in an arrangement direction of the nozzles from positions near outer edges of end portions of the head chips in a longitudinal direction thereof toward central portions of the head chips in the longitudinal direction thereof.

6. The liquid ejection head according to claim 5, characterized in that the head chips are arranged in two lines with a common flow path disposed therebetween, and the strain-reducing portions are provided along each of the lines at the sides facing the common flow path.

7. The liquid ejection head according to claim 5, characterized in that the strain-reducing portions extend over the entire length of the head chips in the longitudinal direction thereof.

8. The liquid ejection head according to claim 5, characterized in that an arrangement pitch of the holes is the same as an arrangement pitch of the nozzles.

9. A liquid ejection head, comprising:
a nozzle plate having nozzles formed therein; and
head chips in which heater elements are arranged in one direction,
wherein the plurality of head chips are arranged on the nozzle plate in series in a line pattern such that each of the heater elements on the head chips is disposed at a position corresponding to each of the nozzles in the nozzle plate, and
first strain-reducing portions formed in the nozzle plate by arranging at least one line of a plurality of holes in a direction perpendicular to an arrangement direction of the nozzles in regions near outer edges of end portions of the head chips in a longitudinal direction thereof; and
second strain-reducing portions formed in the nozzle plate by arranging at least one line of a plurality of holes in the arrangement direction of the nozzles from positions near the outer edges of the end portions of the head chips in the longitudinal direction thereof toward central portions of the head chips in the longitudinal direction thereof.
